(19) United States
(12) Patent Application Publication
(10) Pub. No.: US 2004/0178398 A1
(43) Pub. Date: Sep. 16, 2004

(54) Spun-formed rotatable object with bearing and method of manufacture

(76) Inventors: Bradley D. Miller, Jenison, MI (US); Jeremy J. Gauthier, Kalamazoo, MI (US)

Correspondence Address: Warner Norcross & Judd LLP, 900 Fifth Third Center, 111 Lyon Street, N.W., Grand Rapids, MI, 49503-2487, US

(21) Appl. No.: 10/388,079

(22) Filed: Mar. 13, 2003

(51) Int. Cl. F16H 55/36

(52) U.S. Cl. 254/390; 29/892.1; 474/166

(57) ABSTRACT

The specification discloses a pulley assembly including a spun-formed pulley and a bearing secured within the pulley. The bearing is secured using any combination of press-fitting, adhering, coining, or peening. A manufacturing method also is disclosed.

### BACKGROUND OF THE INVENTION

The present invention relates to rotatable objects, such as pulleys, and more particularly to rotatable objects fabricated by spin-forming.

Rotatable objects, such as pulleys, and their methods of manufacture are well known. This patent application discusses the invention in the specific context of a pulley, but is equally applicable to other rotatable objects, such as wheels.

A pulley includes a hub, a grooved rim, and a web interconnecting the hub and the rim. Relatively low-cost pulleys are fabricated using two techniques.

In a first technique, the pulley is formed by intersecuring two generally identical halves into a sandwich. A bearing can be trapped between the two halves within the hub. Pulleys made in accordance with this technique suffer several shortcomings. First, the two halves can separate during use, resulting in the failure of the machinery on which the pulley is installed. Second, precise alignment of the two halves during manufacture is difficult at best. Often the hub is slightly eccentric with the rim, rather than precisely concentric as desired. Eccentricity, also known as run-out, can result in premature wear of the bearing within the pulley.

In a second technique, the pulley is fabricated using spin-forming technology. The resulting pulley is typically referred to as a “split steel” pulley. In this technique, a metal blank is spun at a relatively high speed; and mandrels and rollers are used to shape the blank into a one-piece pulley. Spin-forming results in at least one advantage and at least one disadvantage. The advantage is that the hub is precisely concentric with the rim. The disadvantage is that, because the pulley a single piece, bearings cannot be trapped between two pulley halves. Consequently, spun-formed pulleys are used in applications in which the pulley is mounted directly on a shaft for rotation with the shaft. Spun-formed pulleys have not been suitable for pulley applications requiring bearings.

### SUMMARY OF THE INVENTION

The aforementioned problems are overcome in the present invention wherein a spun-formed rotatable object, such as a pulley, includes a bearing secured within the object's hub. In the disclosed embodiment, the bearing is press-fit within the object. The bearing may be pressed, coined, and/or glued to the hub to enhance the intersecurement of the two pieces.

In pulley applications, the present invention results in a relatively low-cost, high-precision pulley with a bearing. Because spin-forming is used to create the pulley, the bearing is precisely concentric with the rim. Therefore, the pulley reduces run-out.

These and other objects, advantages, and features of the invention will be more fully understood and appreciated by reference to the Detailed Description of the Preferred Embodiment and the drawings.

### BRIEF DESCRIPTION OF THE DRAWINGS

FIG. 1 is a perspective exploded view of a pulley assembly made in accordance with the present invention;

FIG. 2 is a side elevational view of the pulley;

FIG. 3 is a bottom plan view of the pulley assembly;

FIG. 4 is a top plan view of the pulley assembly;

FIG. 5 is a cross-sectional view of the pulley;

FIG. 6 is a top plan view of the pulley blank prior to spin-forming;

FIG. 7 is a side elevational view of the pulley blank shown in FIG. 6;

FIG. 8 is a top plan view of the pulley blank after spin-forming;

FIG. 9 is a side elevational view of the pulley shown in FIG. 8;

FIG. 10 is a top plan view of a first alternative embodiment of the invention;

FIG. 11 is a side elevation view of the embodiment shown in FIG. 10;

FIG. 12 is a top plan view of a second alternative embodiment of the invention;

FIG. 13 is a side elevation view of the embodiment shown in FIG. 12;

FIG. 14 is a top plan view of a third alternative embodiment of the invention;

FIG. 15 is a side elevation view of the embodiment shown in FIG. 14;

FIG. 16 is a top plan view of a fourth alternative embodiment of the invention; and

FIG. 17 is a side elevation view of the embodiment shown in FIG. 16.

### DETAILED DESCRIPTION OF THE PREFERRED EMBODIMENTS

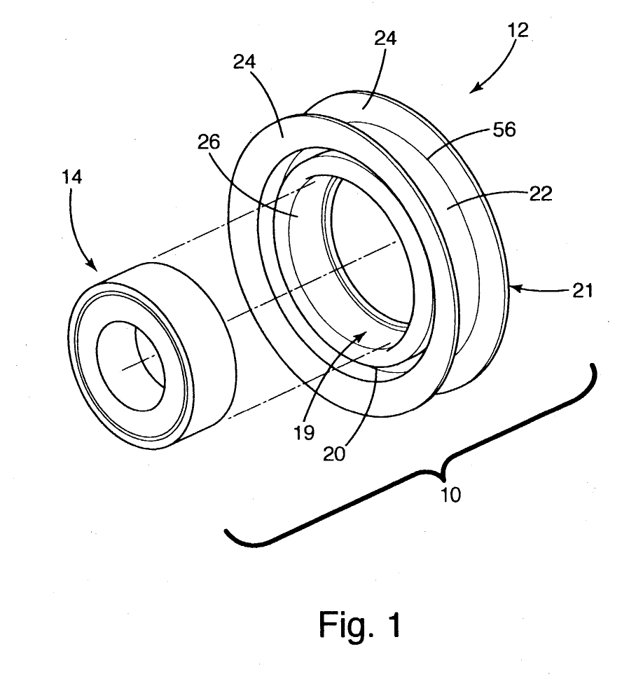

A pulley assembly constructed in accordance with a preferred embodiment of the invention is illustrated in the drawings and generally designated 10. With reference to FIG. 1, the pulley assembly 10 includes a pulley 12 and a bearing 14. The pulley 12 is a single piece including a hub 19, a web 20, and a rim 21. The bearing 14 is secured, preferably by press-fitting, within the hub 19. The pulley 10 can be fabricated of any one of a wide variety of metals.

With reference to FIGS. 1-5, the rim 21 includes a floor 22 and two flanges 24. The floor 22 is connected to the web 20, and each flange 24 is connected to the pulley 12 along one of the upper or lower peripheries 54, 56 of the floor 22.

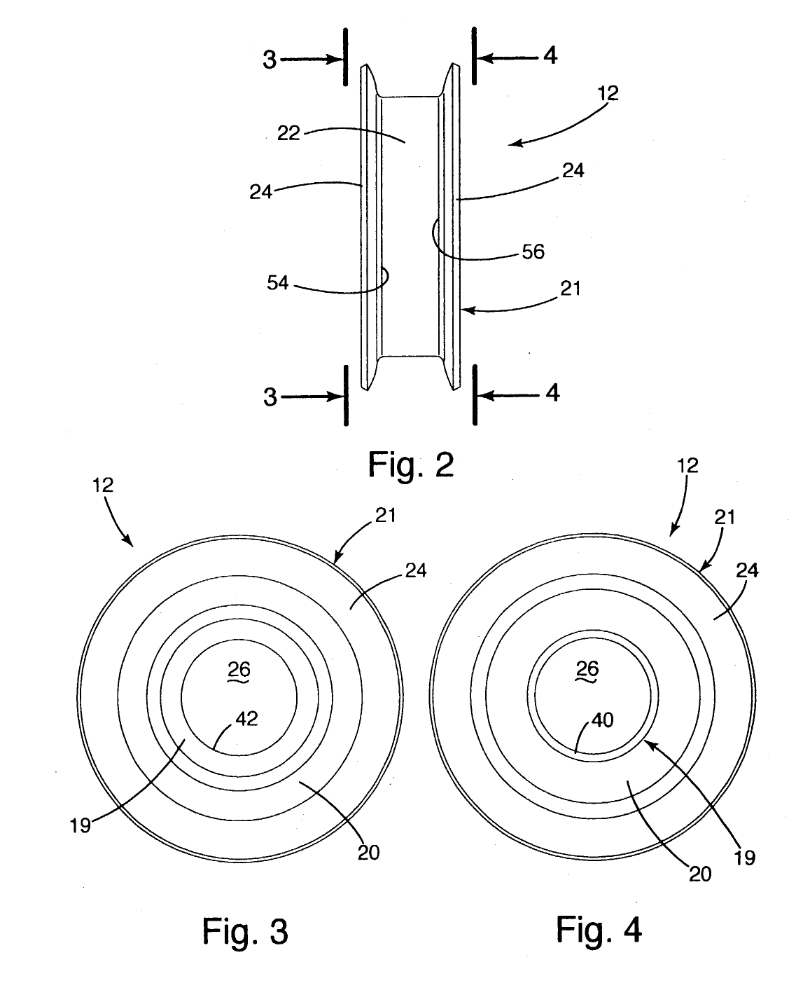

The hub 19 defines a center hole 26. As can be seen from FIGS. 2-4, the center hole 26 is substantially circular, the diameter of the center hole 26 corresponding to the diameter of the bearing 14. The dimensions of the center hole 26 should be such that a close fit exists between the bearing 14 and the center hole 26 when the bearing 14 is incorporated into the pulley. Accordingly, the size and shape of the center hole 26 will vary with the dimensions of the bearing 14. As illustrated, the height of the hub 19 is greater than the height of the bearing 14, but a bearing of any relative size may be used.

The hub 19 includes a lip 40 projecting a short distance inwardly from the top edge 42 of the hub 19. The lip 40 is a substantially flat projection upon which the base of the bearing 14 rests after connection of the bearing 14 to the pulley 12.

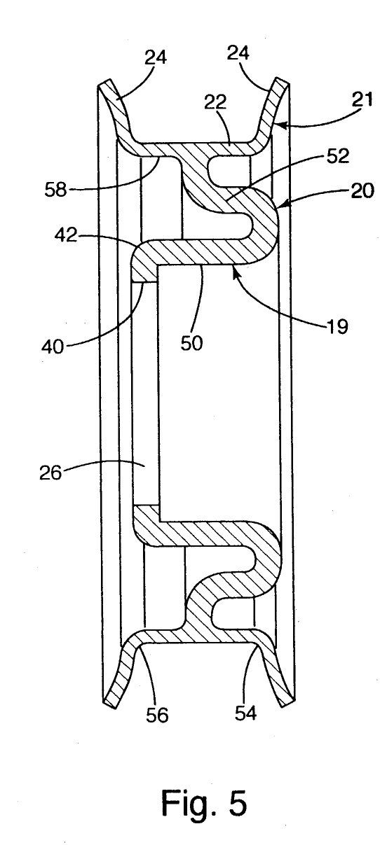

As seen in FIG. 5, the web 20 is substantially S-shaped and includes a first leg 50 and a second leg 52. The first leg 50 projects outwardly from the edge 42 of the hub 19. The second leg 52 extends in the opposite direction from the first leg 50 and is connected to the floor 22, as will be explained in more detail below. The size and shape of the web is relatively unimportant.

The floor 22 of the hub 19 is a continuous flat wall encircling the hub 19. The outer wall has an upper periphery 54, a lower periphery 56 and an inner surface 58. The second leg 52 of the web 20 is preferably connected to the inner surface 58 of the floor 22 at approximately the center of the floor 22.

The flanges 24 are connected to each of the upper periphery 54 and lower periphery 56 of the floor 22. Each flange 24 extends radially outwardly from the floor 22. As disclosed, the flanges 24 protrude from the floor 22 at approximately a 30-degree angle.

The bearing 14 can be any one of a wide variety of suitable bearings known to those skilled in the art. As disclosed, the bearing is press-fit within the hub 19.

### Method of Manufacture

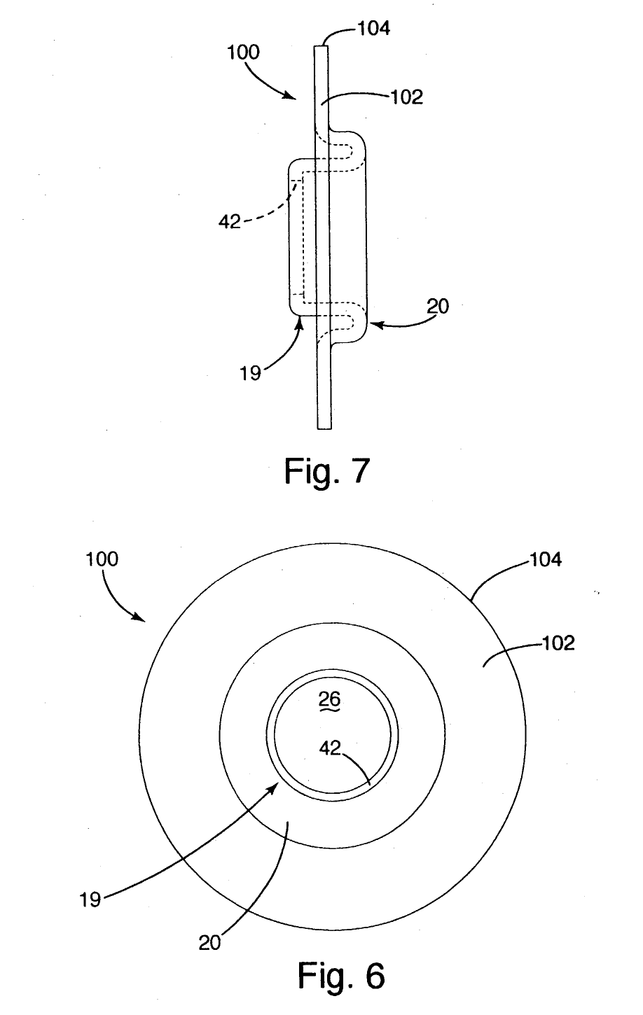

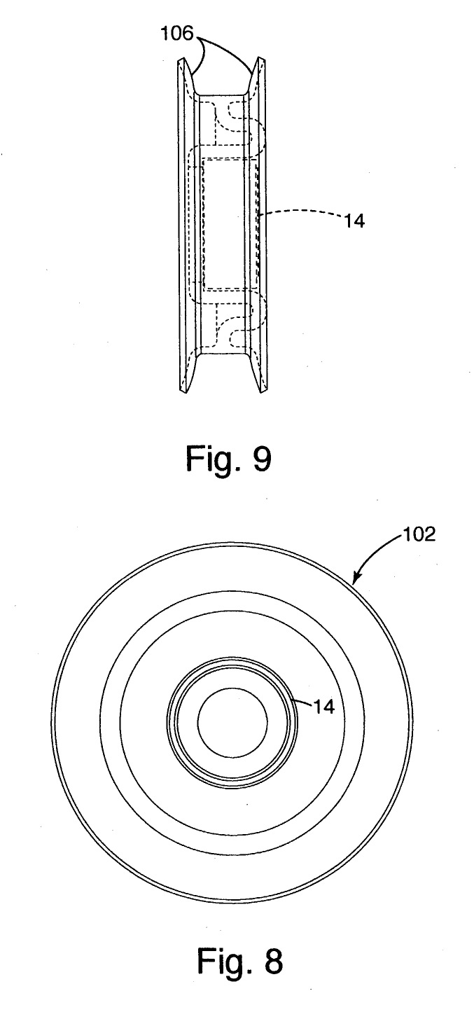

The first step in manufacturing the pulley assembly 10 is to form a blank 100 (FIGS. 6-7) by stamping. The blank 100 is preferably formed of metal and includes the hub 19 and a border 102.

The blank 100 is further shaped by spin-forming. Because spin-forming techniques and equipment are well know to those skilled in the art, the spin-forming equipment is not illustrated. To form the floor 22 and flanges 24 of the pulley 12, the blank 100 is connected to a mandrel of a spin forming machine. As the blank 100 is rotated, rollers are brought into contact with the border 102 of the blank 100. As an initial step, a roller may be used to round the outer edge 104 of the border 102 and to true the border 102, if necessary. Next, a first shaping roller is brought into contact with the outer edge 104 of the border 102 of the blank 100. As the first shaping roller is pressed against the outer edge 104 of the blank 100, the metal of the blank is displaced causing the border 102 to split into two sections. A second shaping roller may then be used to enlarge and shape the gap between the two sections. A third shaping roller is optionally used to further enlarge and shape the gap between the two sections. After the two sections have been expanded the desired distance, a finishing roller is used to complete the shaping of the pulley 12.

The bearing 14 is then press-fit into the spun-formed pulley 12. When press-fit into the hub 19, the base of the bearing 14 lies flat against the lip 40 hub 19 of the hub 19. Because the center hole 26 of the hub 19 is designed to closely receive the bearing 14, frictional forces should permanently retain the bearing 14 in the hub 19 after the bearing 14 is press-fit into the center hole 26. To enhance the press-fit intersecurement and/or as an alternative to the press-fit intersecurement, 1) the hub 19 can be coined, peened, or otherwise shaped, 2) the bearing 14 can be glued to the hub 19 using a metal-to-metal adhesive, and/or 3) other suitable techniques now know or subsequently discovered can be incorporated.

### Alternative Embodiments

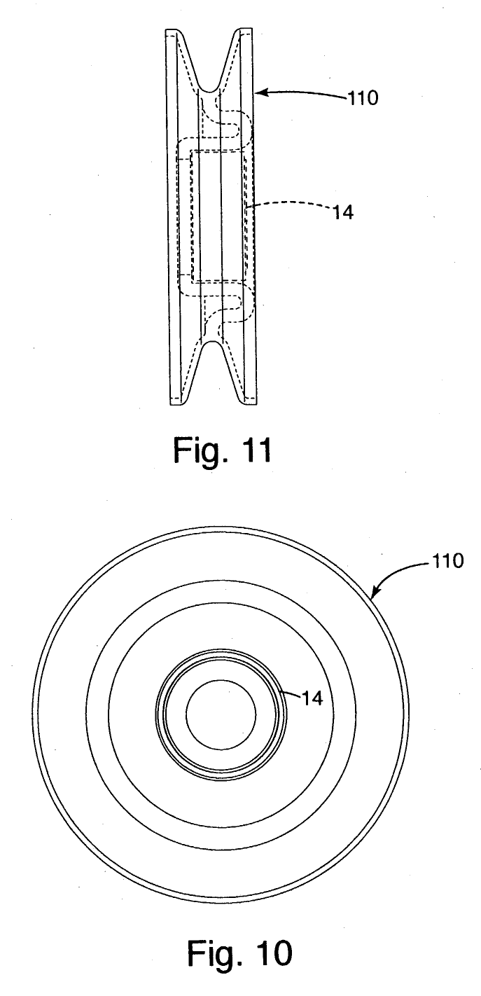

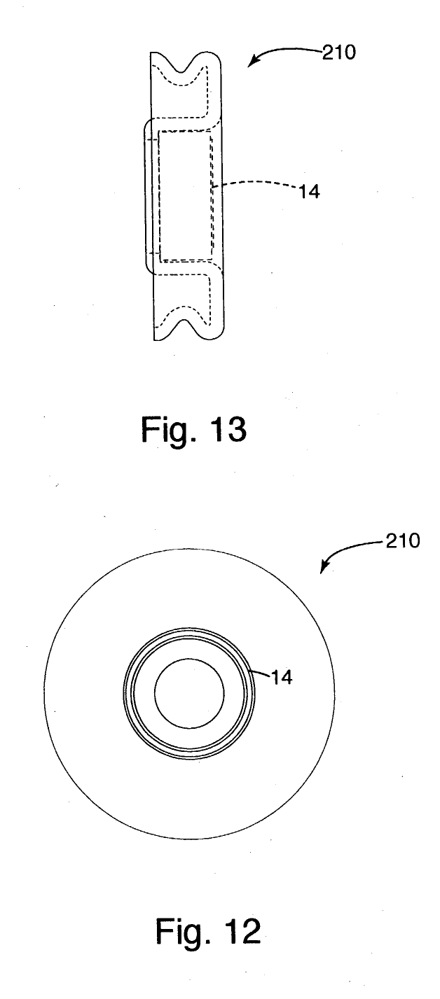

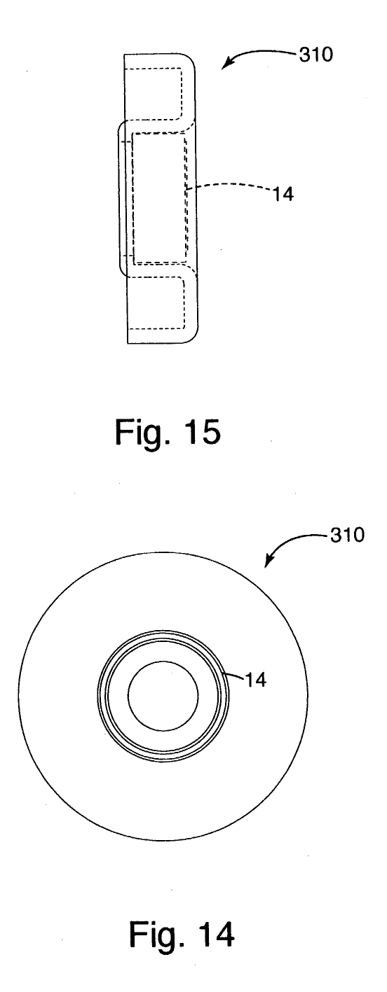

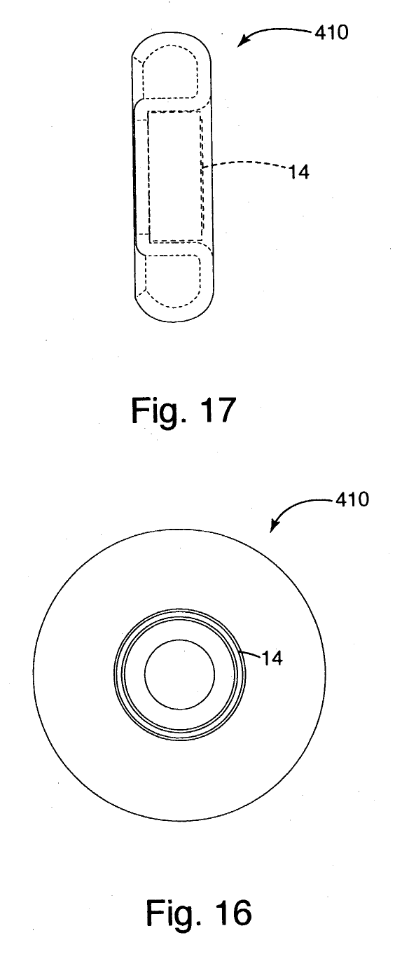

Four alternative embodiments of the rotatable object are illustrated in FIGS. 10-17. The first alternative embodiment 110 (FIGS. 10-11) is a pulley for a V-belt. The second alternative embodiment 210 (FIGS. 12-13) is another pulley for a V-belt. The third alternative embodiment 310 (FIGS. 14-15) is a wheel. And the fourth alternative embodiment 410 (FIGS. 16-17) is another wheel. These four alternative embodiments are included as representative samples of other rotatable assemblies included within the scope of the invention. The configurations of additional possibilities are virtually limitless. All of the alternative embodiments are fabricated using methods similar to the method described above.

The above descriptions are those of preferred embodiments of the invention. Various alterations and changes can be made without departing from the spirit and broader aspects of the invention as defined in the appended claims, which are to be interpreted in accordance with the principles of patent law including the doctrine of equivalents. Any reference to claim elements in the singular, for example, using the articles “a,” “an,” “the” or “said,” is not to be construed as limiting the element to the singular.

The embodiments of the invention in which an exclusive property or privilege is claimed are defined as follows:

1. A rotatable assembly comprising:
a spun-formed object including a hub defining a hole; and
a bearing secured within said hole.

2. An assembly as defined in claim 1 wherein said bearing is press-fit within said hub.

3. An assembly as defined in claim 1 wherein said hub is deformed against said bearing to assist in retaining said bearing within said hub.

4. An assembly as defined in claim 1 wherein said bearing is adhered to said hub.

5. A pulley assembly comprising:
an one-piece pulley including a hub and a rim, said hub defining a center hole; and
a bearing secured within said center hole.

6. The pulley assembly of claim 5 wherein said bearing is press-fit within said hub.

7. The pulley assembly of claim 5 wherein said hub is deformed proximate said bearing to assist in securing said bearing within said hub.

8. The pulley assembly of claim 5 wherein said bearing is adhered to said hub.

9. A method of manufacturing a rotatable assembly comprising the steps of:
spin-forming an object; and
securing a bearing within the object.

10. The method of claim 9 wherein said securing step includes deforming the object to assist in securing the bearing within the object.

11. The method of claim 10 wherein said deforming step includes at least one of peening or swedging the object.

12. The method of claim 9 wherein said securing step includes adhering the bearing to the object.

13. The method of claim 9 wherein the object is a pulley.
